(19) United States
(12) Patent Application Publication
(10) Pub. No.: US 2013/0133204 A1
(43) Pub. Date: May 30, 2013

(54) Wire Stripping Apparatus

(71) Applicants: Adam T. McDannell, Gettysburg, PA (US); Kimberly McDannell, Gettysburg, PA (US)

(72) Inventors: Adam T. McDannell, Gettysburg, PA (US); Kimberly McDannell, Gettysburg, PA (US)

(21) Appl. No.: 13/687,051

(22) Filed: Nov. 28, 2012

Related U.S. Application Data
(60) Provisional application No. 61/564,106, filed on Nov. 28, 2011.

(51) Int. Cl. H02G 1/12

(52) U.S. Cl. CPC H02G 1/1217
USPC 30/90.8

(57) ABSTRACT

An apparatus for stripping insulated wires is provided. The wire stripping apparatus allows a user to remove an insulating outer cover from wires of different diameters so that an inner metal conductor is left exposed for recycling.

### CROSS-REFERENCE

This application claims priority from Provisional Patent Application Ser. No. 61/564,106 filed Nov. 28, 2011.

### FIELD OF THE INVENTION

This invention pertains generally to a wire stripping apparatus, and more particularly to an apparatus for stripping insulation from wire so that the inner metal conductor is removable for use or recycling.

### BACKGROUND

Traditional wire strippers are heavy, bulky, and expensive, making it difficult for the average individual to economically strip wire safely to prepare it for recycling. As it is difficult to strip wires cleanly of their insulation to access the surrounding copper, individuals often attempt to remove the insulating layer by burning it off, thereby releasing dangerous chemicals into the environment and creating an inhalation hazard. Burning wires may be illegal in many areas, making it difficult to inexpensively strip the insulation off of large amounts of copper wire. Others may attempt to use a sharp knife to remove the insulating layer, which can easily result in injury. Unless the copper is separated from the insulation, the wiring must typically be disposed of as trash instead of being recycled.

Consequently, there exists a need for a safe economical tool for removing the insulating outer layer from copper wiring. The present invention discloses an apparatus capable of stripping wires so that only the inner conducting layer remains exposed and intact. The apparatus allows a user to easily strip the outer insulation and jacket from wires of a wide variety of diameters so that the inner copper may be safely removed and recycled.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a wire stripping apparatus. The wire stripping apparatus comprises a plurality of rectangular components secured together into a housing assembly. A plurality of continuous openings is located between the plurality of rectangular components in which a wire is insertable. As the wire passes into one the plurality of continuous openings, one of a plurality of cutting blades penetrates an outer insulating layer of the wire. After the wire emerges, the user simply pulls the insulating layer off of an inner metal conductor.

Furthermore, in a preferred embodiment of the invention, the wire stripping apparatus comprises six continuous openings of different diameters for engaging a variety of different gauged wires. The six continuous openings are formed from aligning a plurality of equally-sized half circle cutouts on opposing sides of a plurality of rectangular components that form a housing assembly. Each of the six continuous openings is penetrated by a cutting blade sandwiched between the plurality of rectangular components which are held in place by a securing element running through the plurality of rectangular components in a perpendicular orientation to the six continuous openings.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of a wire stripping apparatus in accordance with the disclosed architecture.

FIG. 2 illustrates a perspective view of the wire stripping apparatus in accordance with the disclosed architecture.

FIG. 3 illustrates an exploded view of the wire stripping apparatus in accordance with the disclosed architecture.

FIG. 4 illustrates an exploded view of the wire stripping apparatus in accordance with the disclosed architecture.

FIG. 5 illustrates a perspective view of the wire stripping apparatus stripping a wire in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

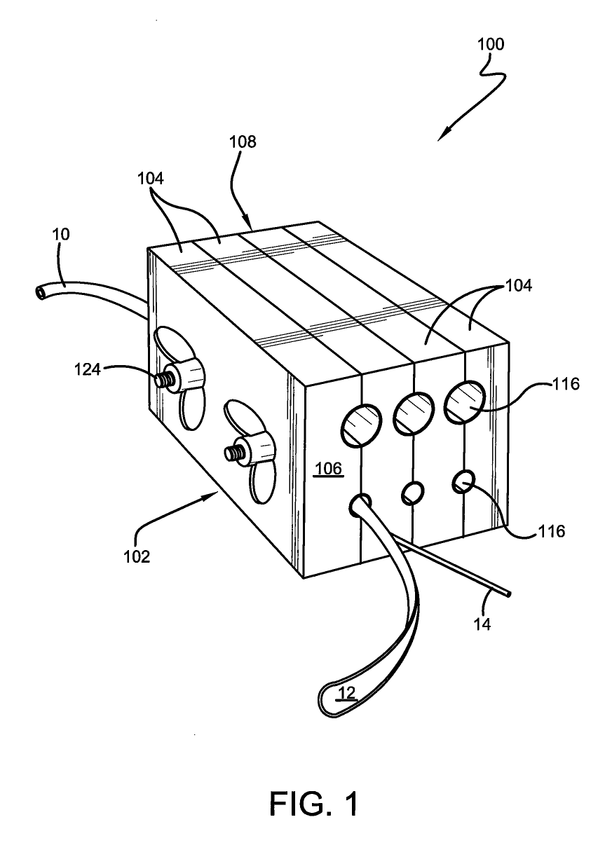

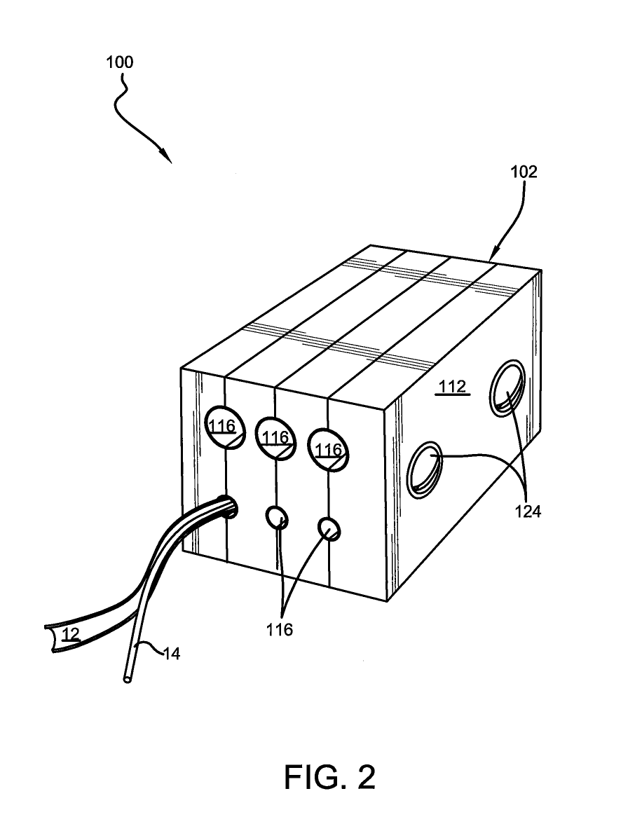

Referring initially to the drawings, FIGS. 1-5 illustrate a wire stripping apparatus 100. The wire stripping apparatus 100 allows a user to remove an insulating outer layer 12 from a wire 10 so that an inner metal conductor 14 of the wire 10 may be exposed. The wire stripping apparatus 100 comprises a housing assembly 102, a plurality of continuous openings 116 for receiving the wire 10, and a plurality of cutting blades 120. The wire stripping apparatus 100 is small enough for hand use, but is also attachable to a work surface with a clamp.

The housing assembly 102 comprises a plurality of rectangular components 104 each having a front face 106, a back face 108, and opposing sides 110. The plurality of rectangular components 104 are typically wood, metal, or plastic in construction, though it is contemplated that the plurality of rectangular components 104 may comprise a variety of materials as are known in the art without affecting the overall scope of the invention. To form the housing assembly 102, the plurality of rectangular components 104 are aligned in a generally parallel configuration and then held together with a securing element 124.

To align the plurality of rectangular components 104 in the generally parallel configuration, opposing sides 110 of the plurality of rectangular components 104 are abutted with each of the front faces 106 facing the same direction. In a preferred embodiment, there are four rectangular components 104 each approximately 2¼ inches in height, 2 inches wide, and 2% inches in depth, however any number of rectangular components 104 can be used. However, the plurality of rectangular components 104 may have varying dimensions as desired to accommodate larger or smaller wires and different work applications. For example, the plurality of rectangular components 104 could be twice as big or twice as small if desired.

The plurality of continuous openings 116 are formed from a plurality of equally-sized half circle cutouts 118 which are formed into the opposing sides 110 of the plurality of rectangular components 104. As the opposing sides 110 of the plurality of rectangular components 104 are abutted, the plurality of equally-sized half circle cutouts 118 are joined together to form the plurality of continuous openings 116. Each of the plurality of continuous openings 116 extend along the opposing sides 110 from the front face 106 to the back face 108 of the plurality of rectangular components 104 creating through holes in the wire stripping apparatus 100 that may each receive a wire or cable for stripping.

In a preferred embodiment, the wire stripping apparatus 100 comprises six continuous openings 116 of different diameters ranging from approximately 1/16 to ½ inches in diameter. This permits a user to strip up to six wires approximately between 0 and 22 in gauge simultaneously. However, this is not meant as a limitation as there may be more or less continuous openings of larger or smaller diameters as desired. In addition, the plurality of continuous openings 116 may have approximately identical diameters. Furthermore, while the plurality of continuous openings 116 are generally approximately circular in shape, they may be flatter in configuration to accommodate non-round wires and cables such as but not limited to Romex®, NM cable, control cables, instrument cables, and the like.

The housing element 102 further comprises a first end 112 and a second end 114. The first end 112 and the second end 114 each have one of the opposing sides containing none of the plurality of equally-sized half circle cutouts 118. Therefore, when assembled, two of the opposing sides 110 of the plurality of rectangular components 104 do not comprise any of the plurality of equally-sized half circle cutouts 118. This is desirable as it allows the housing element 102 to be generally rectangular in construction without indentations or cutouts for easier handling.

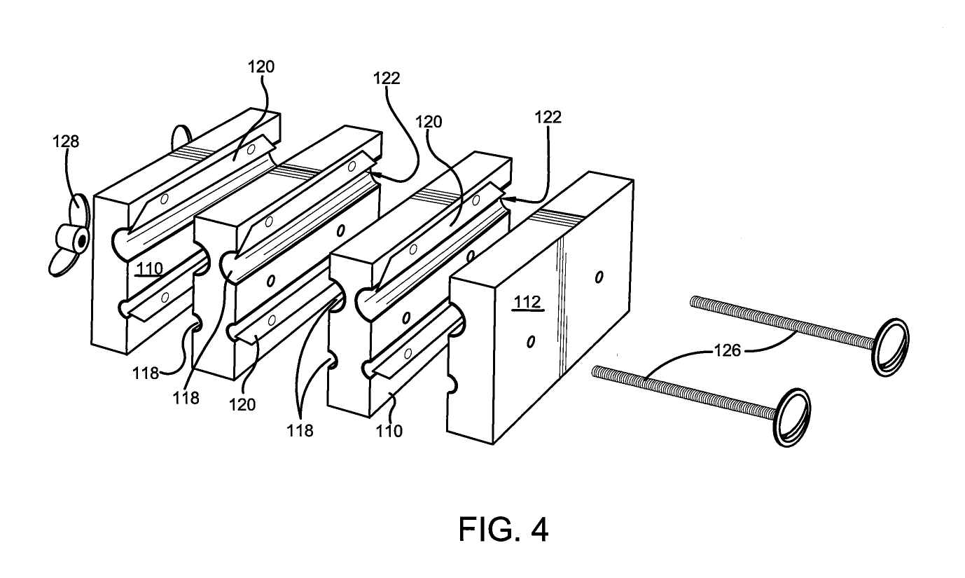

As illustrated in FIG. 4, each of the plurality of cutting blades 120 comprises a cutting edge 122 for extending into each of the plurality of continuous openings 116. The plurality of cutting blades 120 are sandwiched between the opposing sides 110 of the plurality of rectangular components 104 running longitudinally so that they are completely encapsulated within the housing element 102. In other words, the plurality of cutting blades 120 each run generally approximately parallel to each of the plurality of continuous openings 116. However, plurality of cutting blades 120 may also be slightly sloping in comparison to the plurality of continuous openings 116 so that the cutting edges 122 penetrate the plurality of continuous openings 116 at a slight angle from front to back.

In the preferred embodiment, the plurality of cutting blades 120 are positioned between at least three of the opposing sides 110 and are replaceable as the cutting edge 122 becomes dull. Therefore, there are two cutting blades 120 sandwiched between each of the abutted opposing sides 110 so that each of the plurality of continuous openings 116 has a single corresponding cutting blade 120. The plurality of cutting blades 120 are typically razor blades or utility blades, although any other similar thin cutting blade as is known in the art may be used as well.

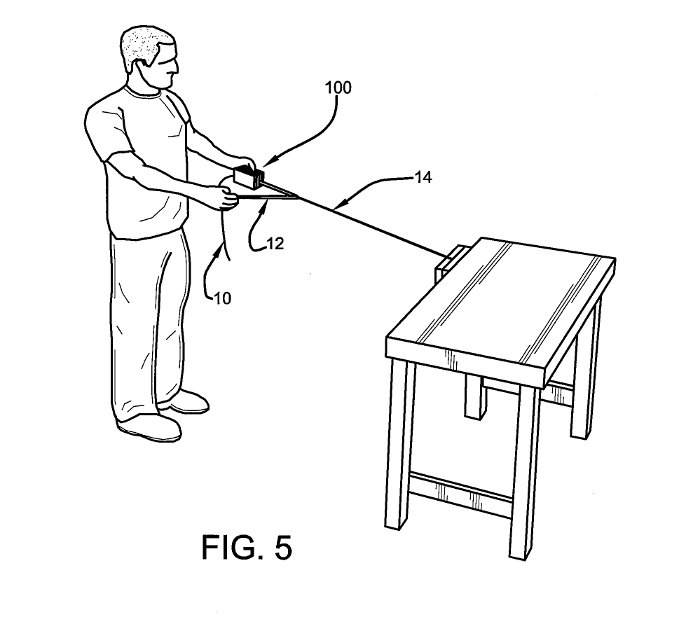

The plurality of cutting blades 120 may be fixed or movable once positioned so that the depth of penetration of the cutting edges 122 into the plurality of continuous openings 116 may be adjusted as desired and held in place with the securing element 124. Typically, the cutting edges 122 penetrate into each of the plurality of continuous openings 116 between approximately 1/16 and ¼ inches. This is advantageous as the cutting edge 122 may then penetrate the outer insulating layer 12 of the wire 10 without cutting into the inner metal conductor 14. As illustrated in FIG. 5, the wire 10 is stripped of the outer insulating layer 12 simply by pushing or pulling the wire 10 through the appropriately sized continuous opening 116.

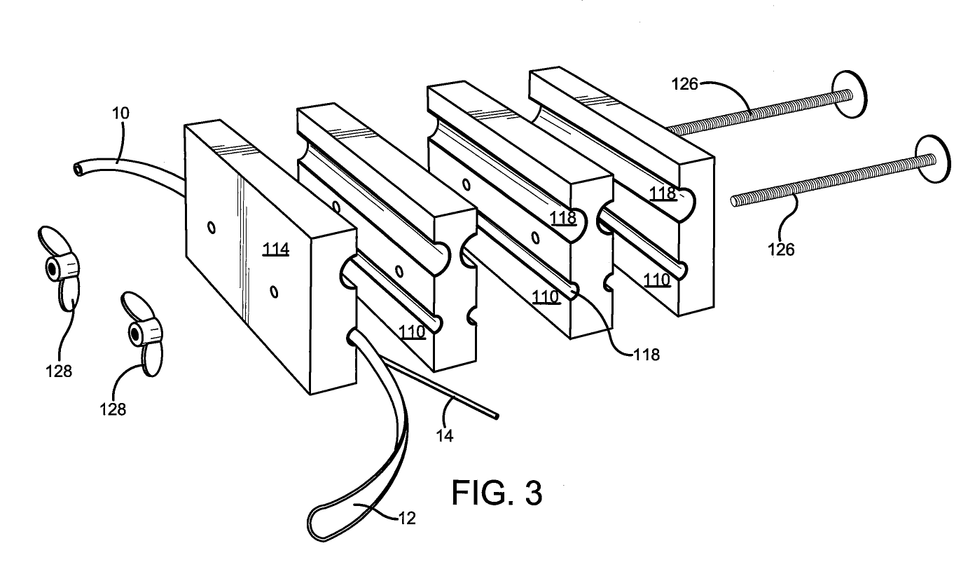

As illustrated in FIG. 3, the securing element 124 runs through each of the plurality of rectangular components 104 generally perpendicularly to the plurality of continuous openings 116. The securing element 124 is typically a pair of bolts 126 and a pair of wing nuts 128. The pair of bolts 126 penetrates the first end 112 of the plurality of rectangular components 104 and are secured by the pair of wing nuts 128 at the second end 114. Once in place, the pair of bolts 126 and wing nuts 128 compresses the plurality of rectangular components 104 thereby securing the housing element 102 in place.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A wire stripping apparatus comprising:
a housing assembly comprising a plurality of rectangular components each comprising a front face, a back face, and opposing sides, wherein the rectangular components are securable in a parallel configuration; and
at least one continuous opening, wherein the at least one continuous opening is formed from joining a plurality of equally-sized half circle cutouts in the opposing sides of the plurality of rectangular components extending from the front face to the back face in each of the plurality of rectangular components; and
at least one cutting blade longitudinally attached to at least one of the opposing sides of the plurality of rectangular components so that the at least one cutting blade extends into the at least one continuous opening.

2. The wire stripping apparatus of claim 1, wherein the plurality of rectangular components are comprised of one of the following materials: wood, plastic, or metal.

3. The wire stripping apparatus of claim 1, wherein two of the opposing sides of the plurality of rectangular components do not comprise a plurality of equally-sized half circle cutouts.

4. The wire stripping apparatus of claim 1, wherein the at least one continuous opening number six continuous openings.

5. The wire stripping apparatus of claim 4, wherein the six continuous openings each comprise a different diameter.

6. The wire stripping apparatus of claim 1, wherein six different sized wires are strippable simultaneously.

7. A wire stripping apparatus comprising:
a housing assembly comprising a plurality of rectangular components each comprising a front face, a back face, and opposing sides, wherein the rectangular components are securable in a parallel configuration; and
a plurality of continuous openings, wherein the plurality of continuous openings are formed from joining a plurality of equally-sized half circle cutouts in the opposing sides of the plurality of rectangular components extending from the front face to the back face in each of the plurality of rectangular components; and
a plurality of cutting blades longitudinally attached to at least three of the opposing sides of the plurality of rectangular components so that the plurality of cutting blades extend into each of the plurality of continuous openings; and
a securing element running through each of the plurality of rectangular components perpendicular to the plurality of continuous openings for holding the plurality of rectangular components together.

8. The wire stripping apparatus of claim 7, wherein the plurality of cutting blades do not extend past the front face or the back face of the plurality or rectangular components.

9. The wire stripping apparatus of claim 7, wherein a cutting edge of each of the plurality of cutting blades is positioned within each of the plurality of continuous openings so that the cutting edge penetrates an outer insulating layer of a wire inserted into the plurality of continuous openings, but leaves an inner metal conductor of the wire intact.

10. The wire stripping apparatus of claim 7, wherein the plurality of cutting blades are replaceable.

11. The wire stripping apparatus of claim 7, wherein the plurality of cutting blades are adjustable in depth within the plurality of continuous openings.

12. The wire stripping apparatus of claim 7, wherein the plurality of cutting blades comprise razor blades or utility blades.

13. The wire stripping apparatus of claim 7, wherein a wire is strippable by pushing or pulling the wire through one of the plurality of continuous openings.

14. A wire stripping apparatus comprising:
a housing assembly comprising a plurality of rectangular components each comprising a front face, a back face, and opposing sides, wherein the rectangular components are securable in a parallel configuration; and
a plurality of continuous openings for receiving a wire, each comprising a different diameter, wherein the plurality of continuous openings are formed from joining a plurality of equally-sized half circle cutouts in the opposing sides of the plurality of rectangular components extending from the front face to the back face in each of the plurality of rectangular components; and
a plurality of cutting blades longitudinally attached to at least three of the opposing sides of the plurality of rectangular components so that the plurality of cutting blades extend into each of the plurality of continuous openings; and
a securing element running through each of the plurality of rectangular components perpendicular to the plurality of continuous openings for compressing the plurality of rectangular components together.

15. The wire stripping apparatus of claim 14, wherein the plurality of continuous openings are between approximately 1/16 and ½ in diameter.

16. The wire stripping apparatus of claim 15, wherein the plurality of openings can accept a wire of between approximately 0 and 22 gauge.

17. The wire stripping apparatus of claim 14, wherein the plurality of cutting blades are six utility blades.

18. The wire stripping apparatus of claim 14, wherein the plurality of cutting blades are angled.

19. The wire stripping apparatus of claim 14, wherein the securing element comprises a pair of bolts and nuts.

20. The wire stripping apparatus of claim 14, wherein the wire stripping apparatus is clampable to a surface.
